(19) United States
(12) Patent Application Publication
(10) Pub. No.: US 2024/0383796 A1
(43) Pub. Date: Nov. 21, 2024

(54) METHOD OF MANUFACTURING OPTICAL FIBER PREFORM AND METHOD OF MANUFACTURING OPTICAL FIBER

(71) Applicant: FURUKAWA ELECTRIC CO., LTD., Tokyo (JP)

(72) Inventors: Keiichi AISO, Tokyo (JP); Osanobu FUKUO, Tokyo (JP); Kazunori MUKASA, Tokyo (JP); Shugo TAKEUCHI, Tokyo (JP)

(73) Assignee: FURUKAWA ELECTRIC CO., LTD., Tokyo (JP)

(21) Appl. No.: 18/607,705

(22) Filed: Mar. 18, 2024

(30) Foreign Application Priority Data
Mar. 31, 2023 (JP) 2023-058763

(51) Int. Cl. C03B 37/012

(52) U.S. Cl. CPC C03B 37/01245; C03B 37/01211; C03B 2205/13; C03B 2205/14

(57) ABSTRACT

In a method of manufacturing an optical fiber preform, from a powder body containing an alkali metal component or an alkaline earth metal component and silica powder, the alkali metal or the alkaline earth metal is diffused into a silica glass tube through a heat treatment, the powder body that is not fixed to the silica glass tube is removed from the silica glass tube, and a cladding portion is formed so as to surround an outer periphery of the silica glass tube.

### CROSS-REFERENCE TO RELATED APPLICATION(S)

This application claims the benefit of priority from Japanese Patent Application No. 2023-058763 filed on Mar. 31, 2023, the entire contents of which are incorporated herein by reference.

### BACKGROUND

### 1. Technical Field

The present disclosure relates to a method of manufacturing an optical fiber preform, and a method of manufacturing an optical fiber.

### 2. Related Art

With the practical application of the digital coherent transmission technology, speed and capacity in optical fiber transmission lines have increased. As a result, transmission systems require a high signal-to-noise ratio (SNR), and optical fibers forming the transmission lines in the optical transmission system require lower transmission loss characteristics.

To reduce the transmission loss in the optical fibers, it is effective to reduce Rayleigh scattering that occurs in the optical fibers. Rayleigh scattering is caused by fluctuations in the dielectric permittivity of glass and occurs due to two factors: the compositional fluctuation and the density fluctuation. The density fluctuation depends on the temperature at which consolidation occurs as glass from a supercooled liquid state (fictive temperature). It has been known that doping an alkali metal in a core portion of an optical fiber significantly lowers the fictive temperature and thus can reduce Rayleigh scattering loss (see the specification of U.S. Pat. No. 5,146,534). Using an alkaline earth metal instead of the alkali metal can also obtain an effect of lowering the fictive temperature.

The following methods have been proposed as the method for doping an alkali metal in a core portion of an optical fiber made of silica glass.

In one of the proposed methods, for example, alkali metal-doped silica core soot is synthesized by a vapor phase axial deposition (VAD) method or an outside vapor deposition (OVD) method and the core soot is dehydrated and made into glass, so that an alkali metal-doped core preform is manufactured (the specification of U.S. Patent Publication No. 2004/0206127). In other proposed methods, alkali metal vapor is introduced into a silica tube of a furnace containing silica core soot to make the alkali metal permeate into and be doped to the silica core soot (Japanese Patent Application Laid-open No. 2013-199399), and an alkali metal is diffused and doped from an outer surface of a silica core preform in a furnace (the specification of U.S. Patent Publication No. 2005/0129376).

In another proposed method, an alkali metal is diffused and doped from the inner surface of a silica tube that serves as a silica core preform by a modified chemical vapor deposition (MCVD) method (Japanese Patent Application Laid-open No. 2012-162409). In still another proposed method, a core rod including a core portion and a glass portion that is adjacent thereto along an outer periphery thereof is disposed inside a glass pipe, a space portion between the core rod and the glass pipe is filled with glass microparticles containing an alkali metal, so that the alkali metal is doped to the core portion (Japanese Patent No. 6719505). In yet still another proposed method, a silica glass body that serves as at least a part of a core portion is formed around an alkali metal-doped silica glass body to which an alkali metal is doped, and the alkali metal is diffused from the alkali metal-doped silica glass body to the silica glass body through heat treatment (Japanese Patent No. 5995923).

### SUMMARY

However, all of the known methods of doping the alkali metal have room for improvement. For example, in the method according to the specification of U.S. Patent Publication No. 2004/0206127, the alkali metal incorporated into the silica soot is easily chlorinated and volatilized by the chlorine gas that flows in the subsequent dehydration process, so that it may be difficult to retain the alkali metal at the desired concentration in the core portion. In the method according to Japanese Patent Application Laid-open No. 2013-199399, impurities such as transition metals contained in the alkali metal material may be doped together with the alkali metal, and if a dehydration and purification process using chlorine is performed to remove the impurities, the alkali metal may volatilize and the desired alkali metal concentration may not be obtained. In addition, in the method according to the specification of U.S. Patent Publication No. 2005/0129376, most of the alkali metal that is used is discharged out of the furnace and therefore, the doping efficiency is considered low. In the method according to Japanese Patent No. 6719505, impurities such as transition metals contained in the glass microparticles including the alkali metal are likely to be mixed, and in optical fibers subsequently manufactured, the impurities may cause optical fiber breakage and increased transmission loss. In the method according to Japanese Patent No. 5995923, cracks may easily occur in a cooling process after an alkali diffusion process due to the large difference in softening temperature between the alkali metal-doped silica glass body and the silica glass body. In addition, there is a problem in that, since the alkali metal-doped silica glass body and the silica glass body are welded together, the alkali metal-doped silica glass body needs to be removed by drilling, making the process complicated.

The present disclosure has been made in view of the above, and an object thereof is to provide a method of manufacturing an optical fiber preform, by which an alkali metal or an alkaline earth metal can be doped easily, efficiently, and sufficiently with fewer impurities, and a method of manufacturing an optical fiber using this.

One aspect of the present disclosure is a method of manufacturing an optical fiber preform, the method including: a first preparing step of preparing a silica glass tube; a second preparing step of preparing a powder body containing an alkali metal component or an alkaline earth metal component, and silica powder; a filling step of filling the silica glass tube with the powder body; a diffusing step of diffusing an alkali metal or an alkaline earth metal into the silica glass tube from the powder body through a heat treatment; a removing step of removing the powder body that is not fixed to the silica glass tube, from the silica glass tube in which the alkali metal or the alkaline earth metal is diffused; and a cladding portion forming step of forming a cladding portion so as to surround an outer periphery of the silica glass tube in which the alkali metal or the alkaline earth metal is diffused.

One aspect of the present disclosure is a method of manufacturing an optical fiber preform, the method including: a first preparing step of preparing a silica glass tube; a second preparing step of preparing a powder body containing an alkali metal component or an alkaline earth metal component, and silica powder; a third preparing step of preparing a silica glass rod; an inserting step of inserting the silica glass rod into the silica glass tube; a filling step of filling a gap between the silica glass tube and the silica glass rod with the powder body; a diffusing step of diffusing an alkali metal or an alkaline earth metal into the silica glass rod from the powder body through a heat treatment; a removing step of removing the powder body that is not fixed to the silica glass rod, from the silica glass rod in which the alkali metal is diffused; and a cladding portion forming step of forming a cladding portion so as to surround an outer periphery of the silica glass rod in which the alkali metal or the alkaline earth metal is diffused.

One aspect of the present disclosure is a method of manufacturing an optical fiber preform, the method including: a first preparing step of preparing a silica glass tube; a second preparing step of preparing a powder body containing an alkali metal component or an alkaline earth metal component, and silica powder; a third preparing step of preparing a silica glass rod; a filling step of filling the silica glass tube with the powder body; a diffusing step of diffusing an alkali metal or an alkaline earth metal into the silica glass tube from the powder body through a heat treatment; a removing step of removing the powder body that is not fixed to the silica glass tube, from the silica glass tube in which the alkali metal or the alkaline earth metal is diffused; a jacketing step of jacketing the silica glass rod with the silica glass tube; and a cladding portion forming step of forming a cladding portion so as to surround an outer periphery of the silica glass tube after the jacketing.

One aspect of the present disclosure is a method of manufacturing an optical fiber, the method including: drawing an optical fiber preform manufactured by the method of manufacturing an optical fiber preform to manufacture an optical fiber.

The foregoing, as well as other features, advantages, and technical and industrial significance of the present disclosure, can be better understood by reading the following detailed description in conjunction with the accompanying drawings.

### BRIEF DESCRIPTION OF THE DRAWINGS

FIG. 1 is a flowchart of a method of manufacturing an optical fiber preform according to a first embodiment;

FIG. 2 is an explanatory view of the method of manufacturing an optical fiber preform according to the first embodiment;

FIG. 3 is an explanatory view of the method of manufacturing an optical fiber preform according to the first embodiment;

FIG. 4 is an explanatory view of the method of manufacturing an optical fiber preform according to the first embodiment;

FIG. 5 is an explanatory view of the method of manufacturing an optical fiber preform according to the first embodiment;

FIG. 6 is an explanatory view of the method of manufacturing an optical fiber preform according to the first embodiment;

FIG. 7 is a flowchart of a method of manufacturing an optical fiber preform according to a second embodiment;

FIG. 8 is an explanatory view of the method of manufacturing an optical fiber preform according to the second embodiment;

FIG. 9 is an explanatory view of the method of manufacturing an optical fiber preform according to the second embodiment;

FIG. 10 is an explanatory view of the method of manufacturing an optical fiber preform according to the second embodiment;

FIG. 11 is an explanatory view of the method of manufacturing an optical fiber preform according to the second embodiment;

FIG. 12 is an explanatory view of the method of manufacturing an optical fiber preform according to the second embodiment;

FIG. 13 is a flowchart of a method of manufacturing an optical fiber preform according to a third embodiment;

FIG. 14 is an explanatory view of the method of manufacturing an optical fiber preform according to the third embodiment; and

FIG. 15 is an explanatory view of the method of manufacturing an optical fiber preform according to the third embodiment.

### DETAILED DESCRIPTION

Embodiments of the present disclosure will be described in detail below with reference to the drawings. The present disclosure is not limited by the embodiments to be described below. In each drawing, the same or corresponding elements are denoted with the same symbol as appropriate. In this specification, terms that are not specifically defined shall follow the definitions and measurement methods in G.650.1 and G.650.2 of the International Telecommunication Union (ITU).

### First Embodiment

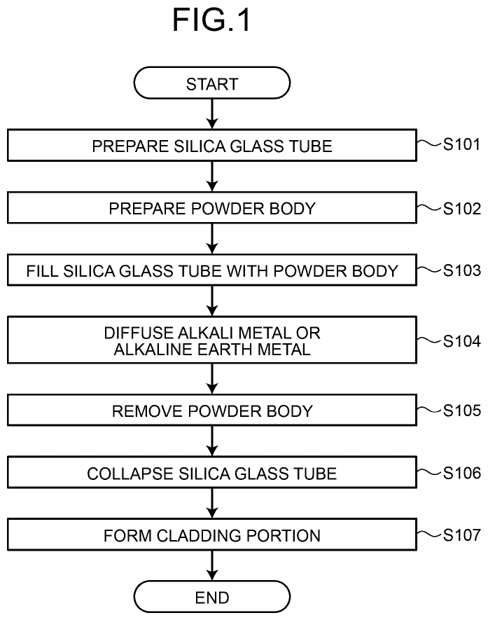

FIG. 1 is a flowchart of a method of manufacturing an optical fiber preform according to a first embodiment. In this manufacturing method, first, a silica glass tube is prepared at step S101 (first preparing step). Then, a powder body containing an alkali metal component or an alkaline earth metal component, and silica powder is prepared at step S102 (second preparing step). Subsequently, the silica glass tube is filled with the powder body at step S103 (filling step). Next, the alkali metal or the alkaline earth metal is diffused from the powder body into the silica glass tube through heat treatment at step S104 (diffusing step). Then, from the silica glass tube in which the alkali metal or the alkaline earth metal is diffused, the powder body that is not fixed to the silica glass tube is removed at step S105 (removing step). Subsequently, the silica glass tube is collapsed at step S106 (collapsing step). Next, a cladding portion is formed so as to surround an outer periphery of the collapsed silica glass tube in which the alkali metal or the alkaline earth metal is diffused at step S107 (cladding portion forming step).

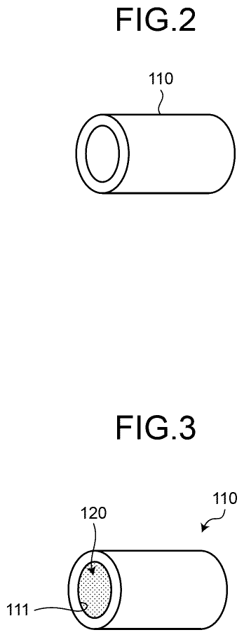

Specific description will be made below. At the first preparing step, a silica glass tube 110 as illustrated in FIG. 2 is prepared by drilling a hole at a central portion of a high-purity silica glass rod manufactured by a VAD method, for example. Note that chlorine may be doped at the manufacture of the silica glass rod. Chlorine is doped for the purpose of, for example, lowering the fictive temperature of the glass. The amount of chlorine to be doped is not limited in particular and is, for example, 8000 ppmwt. Dopants such as fluorine, phosphorus, germanium, or aluminum may be co-doped as needed at the manufacture of the silica glass rod. The silica glass tube may alternatively be prepared using an OVD method, an MCVD method, or a Plasma CVD (PCVD) method.

At the second preparing step, one or more kinds of the following alkali metals are selected as appropriate: lithium (Li), sodium (Na), potassium (K), rubidium (Rb), and cesium (Cs). One or more kinds of the following alkaline earth metals are selected as appropriate: beryllium (Be), magnesium (Mg), calcium (Ca), strontium (Sr), and barium (Ba). The alkali metal or the alkaline earth metal may be contained as at least one kind of alkali metal compound or alkaline earth metal compound among silicates, carbonates, halides, nitrates, sulfates, and hydroxides. High-purity silica powder is preferred, but there is no particular limitation. As for the size of the silica powder, for example, an average particle diameter of 0.1 to 200 μm is given but there is no particular limitation. The powder body containing the alkali metal component or the alkaline earth metal component, and the silica powder can be manufactured by, for example, thoroughly mixing and dispersing the powder body of the alkali metal compound and the silica powder.

At the filling step, the space inside an inner peripheral surface 111 of the silica glass tube 110 is filled with a powder body 120 as illustrated in FIG. 3. In this case, it is preferable to fill the silica glass tube with the powder body 120 so as to satisfy a certain degree or more of bulk density in order to allow sufficient diffusion of the alkali metal or the alkaline earth metal in the silica glass tube at the diffusing step. Therefore, the size of the silica powder is preferably set so that the bulk density becomes a certain degree or more when the silica glass tube is filled.

At the diffusing step, the alkali metal or the alkaline earth metal is diffused into the silica glass tube 110 by keeping a predetermined temperature for a predetermined time using an electric furnace, for example. In some cases, the powder body also contains impurities such as a transition metal (for example, iron) and a hydroxyl group; however, the diffusion coefficient of these impurities in the silica glass is extremely smaller than that of the alkali metal or the alkaline earth metal in the silica glass. Thus, the alkali metal or the alkaline earth metal is selectively diffused into the silica glass tube 110.

At the diffusing step, heat treatment may be performed using a flame such as an oxyhydrogen flame instead of the electric furnace.

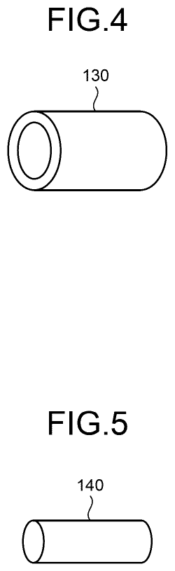

At the removing step, the silica glass tube is tilted or raised vertically to remove the powder body. Alternatively, the silica glass tube may be further vibrated or sprayed with an inert gas to remove the powder body. All of these removing methods are extremely easy to implement. In some cases, the powder body contains impurities, but the impurities are easily removed from the silica glass tube accordingly. Thus, a silica glass tube 130 with the alkali metal diffused inside as illustrated in FIG. 4 is obtained.

At the diffusing step, if the heat treatment is conducted under a condition where sintering of the silica powder does not progress significantly, the fixing of the powder body to the silica glass tube is suppressed or prevented, and therefore, impurities are more easily and securely removed from the silica glass tube. The condition where the sintering of the silica powder does not progress significantly is, for example, when the temperature of the heat treatment is lower than the glass transition temperature of the silica powder.

However, even if the powder body is fixed to the silica glass tube at the diffusing step, the fixing may continue unless there is an influence on the characteristics of the optical fiber that is manufactured later. If, after the removing step, a second removing step is performed to remove the powder body that is fixed to the silica glass tube, the impurities are more securely removed from the silica glass tube. The second removing step can be performed, for example, by grinding or physically or chemically polishing the inner peripheral surface of the silica glass tube.

Furthermore, the impurities may also diffuse into the silica glass tube at the diffusing step. In this case, it is preferable to polish the inner peripheral surface of the silica glass tube by a slight thickness.

At the collapsing step, the silica glass tube is heated and collapsed, and the hole is closed. This causes the silica glass tube 130 to collapse into a rod shape, and thus, a silica glass rod 140 as illustrated in FIG. 5 is obtained. The silica glass rod 140 is an example of a collapsed silica glass tube.

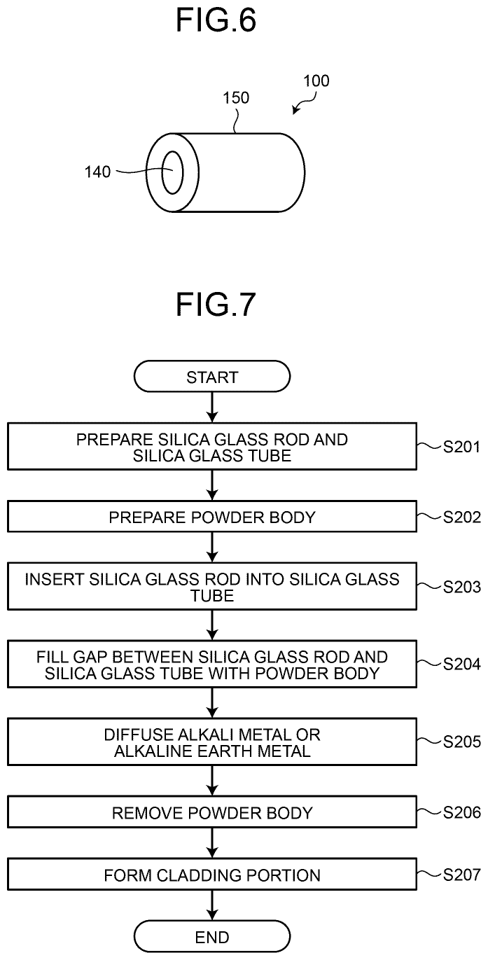

At the cladding portion forming step, a cladding portion 150 is formed using the OVD method so as to surround an outer periphery of the silica glass rod 140 as illustrated in FIG. 6. Thus, an optical fiber preform 100 whose core portion is the silica glass rod 140 with the alkali metal or the alkaline earth metal doped thereto is obtained. Note that fluorine may be doped to the cladding portion 150. The method of forming the cladding portion 150 is not limited to the OVD method; for example, the silica glass rod 140 may be jacketed with a fluorine-doped silica glass tube to form the cladding portion 150.

By drawing the optical fiber preform 100 manufactured as described above in accordance with a known method, an optical fiber with the alkali metal or the alkaline earth metal doped to the core portion can be manufactured.

According to the method of manufacturing the optical fiber preform and the method of manufacturing the optical fiber according to the first embodiment described above, the alkali metal or the alkaline earth metal can be doped sufficiently with fewer impurities to the optical fiber preform and the optical fiber in accordance with a simple procedure.

In particular, since the alkali metal or the alkaline earth metal can be doped with fewer impurities, the breakage of the optical fiber and the increase in transmission loss due to the impurities can be suppressed to a large degree.

By the use of the powder body containing the alkali metal component or the alkaline earth metal component and the silica powder, an alkali metal source or an alkaline earth metal source can be prepared easily. Moreover, the step of removing after the addition can also be simplified.

### Examples 1-1 to 1-9, and Comparative Examples 1 and 2

Optical fiber preforms and optical fibers according to Examples 1-1 to 1-9 were manufactured by the manufacturing methods according to the first embodiment. In each of Examples 1-1 to 1-9, a silica glass tube with an inner diameter of 12 mm and an outer diameter of 30 mm was prepared using a silica glass rod manufactured by the VAD method and having 8000 ppmwt of chlorine doped thereto. As the powder body containing the alkali metal component or the alkaline earth metal component and the silica powder, a powder body was prepared by mixing and dispersing silica powder and potassium carbonate (K₂CO₃). The concentration of potassium carbonate in the powder body was 0.7 wt %.

In Example 1-1, the average particle diameter of the silica powder was 200 μm. The heat treatment temperature at the diffusing step was set at 1,100° C., and the heat treatment was performed at 1, 100° C. for 24 hours. Note that this heat treatment condition corresponds to the condition where the sintering of the silica powder does not progress. However, after the removing step, the inner peripheral surface of the silica glass tube was polished. The inner diameter of the silica glass tube after the polishing was 12.3 mm. The outer diameter of the silica glass rod after the collapsing step (after collapse) was 27.0 mm.

In Example 1-1, the peak concentration of potassium in the silica glass rod after the collapse was chemically analyzed and found to be 0.08 wt %. The concentrations of other impurities (iron, nickel, chromium, aluminum, and hydroxyl group) were less than or equal to the detection limit. Furthermore, the transmission loss of the manufactured optical fiber at a wavelength of 1550 nm was 0.155 dB/km, which was extremely low.

In Example 1-2, the average particle diameter of the silica powder was 200 μm. The heat treatment temperature at the diffusing step was set at 1,200° C., and the heat treatment was performed at 1, 200° C. for 24 hours. This heat treatment condition corresponds to the condition where the sintering of the silica powder does not progress significantly. However, since the heat treatment temperature was higher than that in Example 1-1, the silica powder may have sintered slightly; therefore, after the removing step, the inner peripheral surface of the silica glass tube was polished more than in Example 1-1. The inner diameter of the silica glass tube after the polishing was 12.5 mm. The outer diameter of the silica glass rod after the collapsing step (after collapse) was 26.9 mm.

In Example 1-2, the peak concentration of potassium in the silica glass rod after the collapse was chemically analyzed and found to be 0.10 wt %. The concentrations of other impurities were less than or equal to the detection limit. Furthermore, the transmission loss of the manufactured optical fiber at a wavelength of 1550 nm was 0.155 dB/km, which was extremely low.

In Example 1-3, the average particle diameter of the silica powder was 200 μm. The heat treatment temperature at the diffusing step was set at 1, 300° C., and the heat treatment was performed at 1, 300° C. for 24 hours. This heat treatment condition corresponds to the condition where the sintering of the silica powder does not progress significantly. However, since the heat treatment temperature was higher than that in Example 1-2, the silica powder may have sintered additionally; therefore, after the removing step, the inner peripheral surface of the silica glass tube was polished more than in Example 1-2. After the removing step, the inner peripheral surface of the silica glass tube was polished. The inner diameter of the silica glass tube after the polishing was 12.6 mm. The outer diameter of the silica glass rod after the collapsing step (after collapse) was 26.8 mm.

In Example 1-3, the peak concentration of potassium in the silica glass rod after the collapse was chemically analyzed and found to be 0.11 wt %. The concentrations of other impurities were less than or equal to the detection limit. Furthermore, the transmission loss of the manufactured optical fiber at a wavelength of 1550 nm was 0.156 dB/km, which was extremely low.

In Example 1-4, the average particle diameter of the silica powder was 10 μm. Compared to Examples 1-1 to 1-3, the silica powder had smaller average particle diameter and lower flowability, making it difficult to increase the bulk density at the filling step. In view of this, uniaxial pressure was applied at the filling so as to increase the bulk density while filling. The heat treatment temperature at the diffusing step was set at 1,100° C., and the heat treatment was performed at 1,100° C. for 24 hours. Note that this heat treatment condition corresponds to the condition where the sintering of the silica powder does not progress. However, after the removing step, the inner peripheral surface of the silica glass tube was polished. The inner diameter of the silica glass tube after the polishing was 12.3 mm. The outer diameter of the silica glass rod after the collapsing step (after collapse) was 27.0 mm.

In Example 1-4, the peak concentration of potassium in the silica glass rod after the collapse was chemically analyzed and found to be 0.065 wt %. The concentrations of other impurities were less than or equal to the detection limit. Furthermore, the transmission loss of the manufactured optical fiber at a wavelength of 1550 nm was 0.157 dB/km, which was extremely low.

Comparing Examples 1-1 to 1-3 with Example 1-4, it was found that the silica powder with an average particle diameter of 200 μm was more preferable than that with an average particle diameter of 10 μm in terms of increasing the concentration of potassium to be doped and decreasing the transmission loss.

In Example 1-5, the average particle diameter of the silica powder was 0.1 μm. Since the average particle diameter of the silica powder was even smaller than that in Examples 1-1 to 1-3, potassium carbonate, silica powder, and water were mixed and stirred by a pot mill to manufacture a slurry, which was spray-dried at 150° C. to granulate the slurry. The slurry was then classified into particle diameters ranging from 50 μm to 150 μm and used.

The heat treatment temperature at the diffusing step was set at 1,100° C., and the heat treatment was performed at 1,100° C. for 24 hours. Note that this heat treatment condition corresponds to the condition where the sintering of the silica powder does not progress. However, after the removing step, the inner peripheral surface of the silica glass tube was polished. The inner diameter of the silica glass tube after the polishing was 12.3 mm. The outer diameter of the silica glass rod after the collapsing step (after collapse) was 27.0 mm.

In Example 1-5, the peak concentration of potassium in the silica glass rod after the collapse was chemically analyzed and found to be 0.06 wt %. The concentrations of other impurities were less than or equal to the detection limit. Furthermore, the transmission loss of the manufactured optical fiber at a wavelength of 1550 nm was 0.156 dB/km, which was extremely low.

Note that the method of granulation is not limited to the above method. For example, the slurry may be poured into a tray or the like, dried, and then pulverized in a pulverizer or the like for simple granulation.

In Example 1-6, the average particle diameter of the silica powder was 200 μm. The heat treatment temperature at the diffusing step was set at 1,050° C., and the heat treatment was performed at 1,050° C. for 24 hours. Note that this heat treatment condition corresponds to the condition where the sintering of the silica powder does not progress. However, after the removing step, the inner peripheral surface of the silica glass tube was polished. The inner diameter of the silica glass tube after the polishing was 12.3 mm. The outer diameter of the silica glass rod after the collapsing step (after collapse) was 27.0 mm.

In Example 1-6, the peak concentration of potassium in the silica glass rod after the collapse was chemically analyzed and found to be 0.07 wt %. The concentrations of other impurities were less than or equal to the detection limit. Furthermore, the transmission loss of the manufactured optical fiber at a wavelength of 1550 nm was 0.155 dB/km, which was extremely low.

In Example 1-7, the average particle diameter of the silica powder was 200 μm. The heat treatment temperature at the diffusing step was set at 1,000° C., and the heat treatment was performed at 1,000° C. for 24 hours. Note that this heat treatment condition corresponds to the condition where the sintering of the silica powder does not progress. However, after the removing step, the inner peripheral surface of the silica glass tube was polished. The inner diameter of the silica glass tube after the polishing was 12.3 mm. The outer diameter of the silica glass rod after the collapsing step (after collapse) was 27.0 mm.

In Example 1-7, the peak concentration of potassium in the silica glass rod after the collapse was chemically analyzed and found to be 0.06 wt %. The concentrations of other impurities were less than or equal to the detection limit. Furthermore, the transmission loss of the manufactured optical fiber at a wavelength of 1550 nm was 0.156 dB/km, which was extremely low.

In Example 1-8, the average particle diameter of the silica powder was 200 μm. The heat treatment temperature at the diffusing step was set at 900° C., and the heat treatment was performed at 900° C. for 24 hours. Note that this heat treatment condition corresponds to the condition where the sintering of the silica powder does not progress. However, after the removing step, the inner peripheral surface of the silica glass tube was polished. The inner diameter of the silica glass tube after the polishing was 12.2 mm. The outer diameter of the silica glass rod after the collapsing step (after collapse) was 27.0 mm.

In Example 1-8, the peak concentration of potassium in the silica glass rod after the collapse was chemically analyzed and found to be 0.04 wt %. The concentrations of other impurities were less than or equal to the detection limit. Furthermore, the transmission loss of the manufactured optical fiber at a wavelength of 1550 nm was 0.158 dB/km, which was extremely low.

Comparing Examples 1-1 to 1-3 and 1-6 to 1-8, it was confirmed that substantially the same transmission loss was able to be achieved in the heat treatment temperature range of 1000° C. to 1300° C.

In Example 1-9, the average particle diameter of the silica powder was 200 μm. The heat treatment temperature at the diffusing step was set at 1,400° C., and the heat treatment was performed at 1,400° C. for 24 hours. Note that the heat treatment condition corresponds to the condition where the sintering of the silica powder progresses relatively. In view of this, after the removing step, the inner peripheral surface of the silica glass tube was polished relatively thickly. The inner diameter of the silica glass tube after the polishing was 12.7 mm. The outer diameter of the silica glass rod after the collapsing step (after collapse) was 26.8 mm.

In Example 1-9, the peak concentration of potassium in the silica glass rod after the collapse was chemically analyzed and found to be 0.14 wt %. The concentrations of other impurities were less than or equal to the detection limit. Furthermore, the transmission loss of the manufactured optical fiber at a wavelength of 1550 nm was 0.158 dB/km, which was extremely low.

In contrast to these, in Comparative Example 1, the average particle diameter of the silica powder was 200 μm. The heat treatment temperature at the diffusing step was set to 800° C., and the heat treatment was performed at 800° C. for 24 hours. Note that this heat treatment condition corresponds to the condition where the sintering of the silica powder does not progress. However, after the removing step, the inner peripheral surface of the silica glass tube was polished. The inner diameter of the silica glass tube after the polishing was 12.2 mm. The outer diameter of the silica glass rod after the collapsing step (after collapse) was 27.0 mm.

In Comparative Example 1, the peak concentration of potassium in the silica glass rod after the collapse was chemically analyzed and found to be less than or equal to the detection limit. The concentrations of other impurities were also less than or equal to the detection limit. Furthermore, the transmission loss of the manufactured optical fiber at a wavelength of 1550 nm was 0.167 dB/km, which was low but higher than the values in the other Examples.

In Comparative Example 2, a silica glass rod to which chlorine was doped by 10000 ppmwt manufactured by the VAD method was prepared. For this silica glass rod, a fluorine-doped cladding portion was formed using the OVD method and thus, the optical fiber preform was obtained. The transmission loss of the optical fiber manufactured from this optical fiber preform at a wavelength of 1550 nm was 0.170 dB/km, which was relatively high.

### Second Embodiment

FIG. 7 is a flowchart of a method of manufacturing an optical fiber preform according to a second embodiment. In this manufacturing method, a silica glass rod and a silica glass tube are prepared first at step S201 (first preparing step and third preparing step). Then, a powder body containing an alkali metal component or an alkaline earth metal component, and silica powder is prepared at step S202 (second preparing step). Subsequently, the silica glass rod is inserted into the silica glass tube at step S203 (inserting step). Then, a gap between the silica glass tube and the silica glass rod is filled with the powder body at step S204 (filling step). Next, the alkali metal or the alkaline earth metal is diffused from the powder body into the silica glass rod through heat treatment at step S205 (diffusing step). Then, from the silica glass rod in which the alkali metal is diffused, the powder body that is not fixed to the silica glass rod is removed at step S206 (removing step). Then, the cladding portion is formed so as to surround an outer periphery of the silica glass rod in which the alkali metal or the alkaline earth metal is diffused at step S207 (cladding portion forming step).

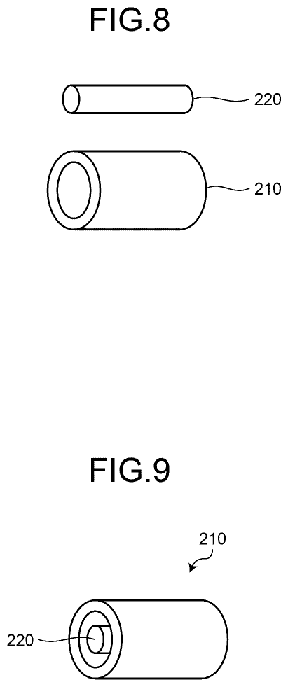

Specific description will be made below. At the first preparing step, in a manner similar to the first embodiment, a silica glass tube 210 as illustrated in FIG. 8 is prepared by drilling a hole at a central portion of a high-purity silica glass rod manufactured by the VAD method, for example. However, the silica glass rod does not need to have high purity and dopants such as chlorine, fluorine, phosphorus, germanium, or aluminum do not need to be doped. The silica glass tube 210 may be, for example, a commercially available silica glass tube not having high purity.

At the third preparing step, for example, as illustrated in FIG. 8, a high-purity silica glass rod 220 manufactured by the VAD method is prepared. Note that chlorine may be doped at the manufacture of the silica glass rod. The amount of chlorine to be doped is not limited in particular and is, for example, 8000 ppmwt. Dopants such as fluorine, phosphorus, germanium, or aluminum may be co-doped as needed at the manufacture of the silica glass rod. The silica glass rod may alternatively be prepared using the OVD method, the MCVD method, or the PCVD method.

The second preparing step is similar to that in the first embodiment and therefore, the description thereof is omitted.

At the inserting step, the silica glass rod 220 is inserted into the silica glass tube 210 as illustrated in FIG. 9.

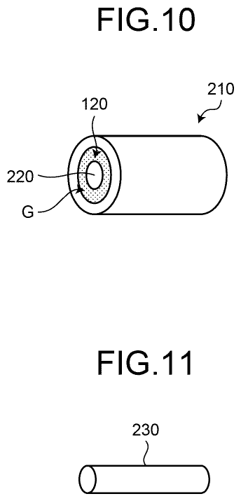

At the filling step, a gap G between the silica glass tube 210 and the silica glass rod 220 is filled with the powder body 120 as illustrated in FIG. 10. At this time, in a manner similar to the first embodiment, it is preferable to fill with the powder body 120 so as to satisfy the desired bulk density.

At the diffusing step, the alkali metal or the alkaline earth metal is diffused into the silica glass rod 220 by keeping a predetermined temperature for a predetermined time using an electric furnace, for example. At this time, in a manner similar to the first embodiment, the alkali metal or the alkaline earth metal is selectively diffused into the silica glass rod 220.

At the removing step, in a manner similar to the first embodiment, the silica glass rod may be vibrated or sprayed with an inert gas to remove the powder body. Thus, a silica glass rod 230 with the alkali metal diffused inside as illustrated in FIG. 11 is obtained.

Note that, at the diffusing step, in a manner similar to the first embodiment, the heat treatment may be performed under the condition where the sintering of the silica powder does not progress significantly.

Additionally, in a manner similar to the first embodiment, a second removing step may be performed to remove the powder body that is fixed to the silica glass rod after the removing step.

Furthermore, since the impurities may diffuse into the silica glass rod at the diffusing step, an outer peripheral surface of the silica glass rod may be polished by a slight thickness.

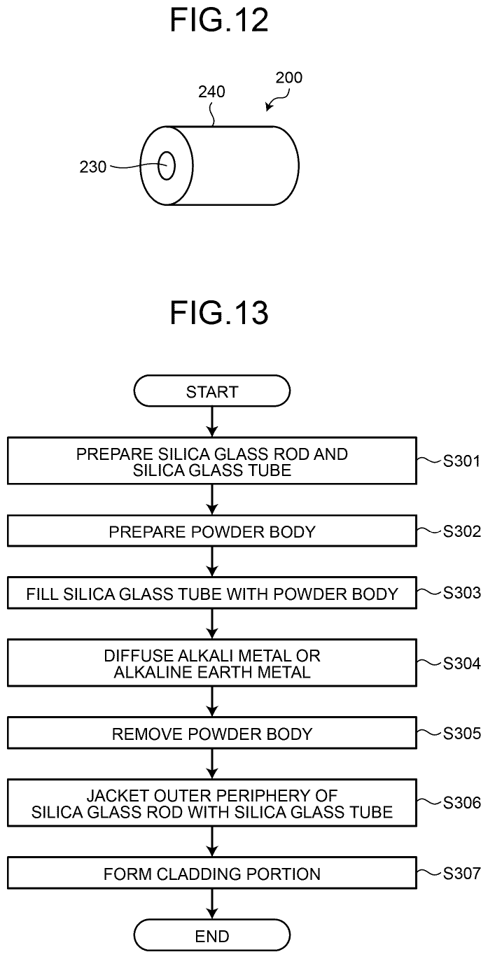

At the cladding portion forming step, a cladding portion 240 is formed so as to surround an outer periphery of the silica glass rod 230 as illustrated in FIG. 12 in a manner similar to the first embodiment. Thus, an optical fiber preform 200 whose core portion is the silica glass rod 230 with the alkali metal or the alkaline earth metal doped thereto is obtained.

By drawing the optical fiber preform 200 manufactured as described above in accordance with a known method, the optical fiber with the alkali metal or the alkaline earth metal doped to the core portion can be manufactured.

According to the method of manufacturing the optical fiber preform and the method of manufacturing the optical fiber according to the second embodiment described above, the alkali metal or the alkaline earth metal can be doped sufficiently with fewer impurities to the optical fiber preform and the optical fiber in accordance with a simple procedure in a manner similar to the first embodiment.

### Example 2

An optical fiber preform and an optical fiber according to Example 2 were manufactured by the manufacturing methods according to the second embodiment. In Example 2, a silica glass rod to which chlorine was doped by 8000 ppmwt manufactured by the VAD method was prepared. The outer diameter of the silica glass rod was 15 mm. Moreover, a commercial silica glass tube with an inner diameter of 35 mm and an outer diameter of 45 mm was prepared. As the powder body containing the alkali metal component or the alkaline earth metal component and the silica powder, a powder body was prepared by mixing and dispersing silica powder with an average particle diameter of 200 μm and potassium carbonate. The concentration of potassium carbonate in the powder body was 0.7 wt %.

The heat treatment temperature at the diffusing step was set at 1,100° C., and the heat treatment was performed at 1,100° C. for 24 hours. Note that this heat treatment condition corresponds to the condition where the sintering of the silica powder does not progress. However, after the removing step, an outer peripheral surface of the silica glass rod was polished. The outer diameter of the silica glass rod after the polishing was 14.7 mm. The outer diameter of the silica glass tube (core rod) after the jacketing and the collapse was 29.0 mm.

In Example 3, the peak concentration of potassium in the silica glass rod was chemically analyzed and found to be 0.09 wt %. The concentrations of other impurities were less than or equal to the detection limit.

Furthermore, the transmission loss of the manufactured optical fiber at a wavelength of 1550 nm was 0.156 dB/km, which was extremely low.

### Third Embodiment

FIG. 13 is a flowchart of a method of manufacturing an optical fiber preform according to a third embodiment. In this manufacturing method, a silica glass rod and a silica glass tube are prepared first at step S301 (first preparing step and third preparing step). Then, a powder body containing an alkali metal component or an alkaline earth metal component, and silica powder is prepared at step S302 (second preparing step). Subsequently, the silica glass tube is filled with the powder body at step S303 (filling step). Next, the alkali metal or the alkaline earth metal is diffused from the powder body into the silica glass tube through heat treatment at step S304 (diffusing step). Then, from the silica glass tube in which the alkali metal is diffused, the powder body that is not fixed to the silica glass tube is removed at step S305 (removing step). Then, the silica glass rod is jacketed with the silica glass tube at step S306 (jacketing step). Next, a cladding portion is formed so as to surround an outer periphery of the silica glass tube after the jacketing at step S307 (cladding portion forming step).

Specific description will be made below. At the first preparing step, in a manner similar to the first embodiment, the silica glass tube is prepared by drilling a hole at a central portion of a high-purity silica glass rod manufactured by the VAD method, for example. Note that chlorine may be doped at the manufacture of the silica glass tube. Dopants such as fluorine, phosphorus, germanium, or aluminum may be co-doped as needed at the manufacture of the silica glass tube.

At the third preparing step, in a manner similar to the second embodiment, a high-purity silica glass rod manufactured by the VAD method is prepared, for example. Note that chlorine may be doped at the manufacture of the silica glass rod. Dopants such as fluorine, phosphorus, germanium, or aluminum may be co-doped as needed at the manufacture of the silica glass rod.

The second preparing step is similar to that in the first and second embodiments and therefore, the description thereof is omitted.

The filling step, the diffusing step, and the removing step are similar to those in the first embodiment and therefore, the description thereof is omitted. In addition, the second removing step may be performed after the removing step, or an inner peripheral surface of the silica glass tube may be polished by a slight thickness.

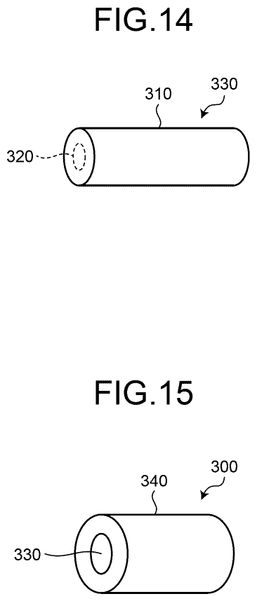

At the jacketing step, as illustrated in FIG. 14, a silica glass rod 320 is jacketed with a silica glass tube 310, which are then integrated by heating to form a core glass rod 330. The gap between the silica glass tube 310 and the silica glass rod 320 is closed by the collapse of the silica glass tube 310.

At the cladding portion forming step, a cladding portion 340 is formed so as to surround an outer periphery of the core glass rod 330 as illustrated in FIG. 15 in a manner similar to the first and second embodiments. Thus, an optical fiber preform 300 whose core portion is the core glass rod 330 with the alkali metal or the alkaline earth metal doped thereto is obtained.

By drawing the optical fiber preform 300 manufactured as described above in accordance with a known method, the optical fiber with the alkali metal or the alkaline earth metal doped to the core portion can be manufactured.

According to the method of manufacturing the optical fiber preform and the method of manufacturing the optical fiber according to the third embodiment described above, the alkali metal or the alkaline earth metal can be doped sufficiently with fewer impurities to the optical fiber preform and the optical fiber in accordance with a simple procedure in a manner similar to the first and second embodiments.

### Example 3

An optical fiber preform and an optical fiber according to Example 3 were manufactured by the manufacturing methods according to the third embodiment. In Example 3, a silica glass rod having 8000 ppmwt of chlorine doped thereto and a silica glass tube having 2000 ppmwt of chlorine and 1.1 wt % of fluorine doped thereto, which were manufactured by the VAD method, were prepared. The outer diameter of the silica glass rod was 10.5 mm. The inner diameter of the silica glass tube was 12 mm and the outer diameter thereof was 30 mm. As the powder body containing the alkali metal component or the alkaline earth metal component and the silica powder, a powder body was prepared by mixing and dispersing silica powder with an average particle diameter of 200 μm and potassium carbonate. The concentration of potassium carbonate in the powder body was 0.7 wt %.

The heat treatment temperature at the diffusing step was set at 1,100° C., and the heat treatment was performed at 1,100° C. for 24 hours. Note that this heat treatment condition corresponds to the condition where the sintering of the silica powder does not progress. However, after the removing step, an inner peripheral surface of the silica glass tube was polished. The inner diameter of the silica glass tube after the polishing was 12.3 mm. The outer diameter of the silica glass tube (core glass rod) after the jacketing and the collapse was 29.0 mm.

In Example 3, the peak concentration of potassium in the core glass rod was chemically analyzed and found to be 0.08 wt %. The concentrations of other impurities were less than or equal to the detection limit. Furthermore, the transmission loss of the manufactured optical fiber at a wavelength of 1550 nm was 0.155 dB/km, which was extremely low.

Tables 1 and 2 below show the manufacturing conditions and results in Examples 1-1 to 1-9, Examples 2 and 3, and Comparative Example 1.

TABLE 1

| | | Example | Example | Example | Example | Example |
|---|---|---|---|---|---|---|
| | | 1-1 | 1-2 | 1-3 | 1-4 | 1-5 |
| Outer diameter of silica | | — | — | — | — | — |
| glass rod (mm) | | | | | | |
| Outer diameter of silica | | 30 | 30 | 30 | 30 | 30 |
| glass tube (mm) | | | | | | |
| Inner diameter of silica | | 12 | 12 | 12 | 12 | 12 |
| glass tube (mm) | | | | | | |
| Concentration of doped | | — | — | — | — | — |
| fluorine in silica glass | | | | | | |
| tube (wt %) | | | | | | |
| Powder | Average particle | 200 | 200 | 200 | 10 | 0.1 |
| body | diameter of silica | | | | | |
| | powder (μm) | | | | | |
| | Concentration of | 0.7 | 0.7 | 0.7 | 0.7 | 0.7 |
| | potassium silicate | | | | | |
| | (wt %) | | | | | |
| | Slurry diameter | — | — | — | — | 50-150 |
| | (μm) | | | | | |
| Heating | Temperature | 1,100 | 1,200 | 1,300 | 1,100 | 1,100 |
| condition | (° C.) | | | | | |
| | Time (hour) | 24 | 24 | 24 | 24 | 24 |

| | | | | | |
|---|---|---|---|---|---|
| Inner diameter of silica glass | 12.3 | 12.5 | 12.6 | 12.3 | 12.3 |
| tube after polishing (mm) | | | | | |
| Outer diameter of silica glass | 27.0 | 26.9 | 26.8 | 27.0 | 27.0 |
| rod (mm) (after collapse) | | | | | |
| Peak concentration of | 0.08 | 0.10 | 0.11 | 0.065 | 0.060 |
| potassium (wt %) | | | | | |
| Transmission loss (dB/km) | 0.155 | 0.155 | 0.156 | 0.157 | 0.156 |
| (@1550 nm) | | | | | |

TABLE 2

| | | Example | Example | Example | Example | Comparative | Example | Example |
|---|---|---|---|---|---|---|---|---|
| | | 1-6 | 1-7 | 1-8 | 1-9 | Example 1 | 2 | 3 |
| Outer diameter of silica | | — | — | — | — | — | 15 | 10.5 |
| glass rod (mm) | | | | | | | | |
| Outer diameter of silica | | 30 | 30 | 30 | 30 | 30 | 45 | 30 |
| glass tube (mm) | | | | | | | | |
| Inner diameter of silica | | 12 | 12 | 12 | 12 | 12 | 35 | 12 |
| glass tube (mm) | | | | | | | | |
| Concentration of doped | | — | — | — | — | — | — | 1.1 |
| fluorine in silica glass | | | | | | | | |
| tube (wt %) | | | | | | | | |
| Powder | Average particle | 200 | 200 | 200 | 200 | 200 | 200 | 200 |
| body | diameter of silica | | | | | | | |
| | powder (μm) | | | | | | | |
| | Concentration of | 0.7 | 0.7 | 0.7 | 0.7 | 0.7 | 0.7 | 0.7 |
| | potassium silicate | | | | | | | |
| | (wt %) | | | | | | | |
| | Slurry diameter | — | — | — | — | — | — | — |
| | (μm) | | | | | | | |
| Heating | Temperature | 1,050 | 1,000 | 900 | 1,400 | 800 | 1,100 | 1,100 |
| condition | (° C.) | | | | | | | |
| | Time (hour) | 24 | 24 | 24 | 24 | 24 | 24 | 24 |

| | | | | | | | |
|---|---|---|---|---|---|---|---|
| Inner diameter of silica glass | 12.3 | 12.3 | 12.2 | 12.7 | 12.2 | — | 12.3 |
| tube after polishing (mm) | | | | | | | |
| Outer diameter of silica glass | 27.0 | 27.0 | 27.0 | 26.8 | 27.0 | 14.7 | 29.0 |
| rod (mm) (after collapse or | | | | | | | |
| after polishing) | | | | | | | |
| Peak concentration of | 0.07 | 0.06 | 0.04 | 0.14 | — | 0.09 | 0.08 |
| potassium (wt %) | | | | | | | |
| Transmission loss (dB/km) | 0.155 | 0.156 | 0.158 | 0.158 | 0.167 | 0.156 | 0.155 |
| (@1550 nm) | | | | | | | |

In the above first embodiment, the collapsing step of collapsing the silica glass tube is performed after the diffusing step and before the cladding portion forming step; however, when the diameter of the hole of the silica glass tube is small, the collapsing may be performed in the process of drawing the optical fiber.

In the powder body containing the alkali metal component or the alkaline earth metal component and the silica powder, the alkali metal component or the alkaline earth metal component may be contained as a component of the silica powder.

According to the present disclosure, the method of manufacturing the optical fiber preform, by which the alkali metal or the alkaline earth metal can be doped sufficiently with fewer impurities in accordance with a simple procedure, and the method of manufacturing the optical fiber using this can be achieved.

The present disclosure is not limited by the above embodiments. A combination of the above components as appropriate is also included in the present disclosure. Other effects and modifications can be easily derived by those skilled in the art. Thus, the broader aspects of the present disclosure are not limited to the above embodiments, and various changes are possible.

What is claimed is:

1. A method of manufacturing an optical fiber preform, the method comprising:
a first preparing step of preparing a silica glass tube;
a second preparing step of preparing a powder body containing an alkali metal component or an alkaline earth metal component, and silica powder;
a filling step of filling the silica glass tube with the powder body;
a diffusing step of diffusing an alkali metal or an alkaline earth metal into the silica glass tube from the powder body through a heat treatment;
a removing step of removing the powder body that is not fixed to the silica glass tube, from the silica glass tube in which the alkali metal or the alkaline earth metal is diffused; and
a cladding portion forming step of forming a cladding portion so as to surround an outer periphery of the silica glass tube in which the alkali metal or the alkaline earth metal is diffused.

2. The method of manufacturing an optical fiber preform according to claim 1, further comprising a collapsing step of collapsing the silica glass tube after the diffusing step and before the cladding portion forming step, wherein at the cladding portion forming step, the cladding portion is formed so as to surround the outer periphery of the collapsed silica glass tube in which the alkali metal or the alkaline earth metal is diffused.

3. The method of manufacturing an optical fiber preform according to claim 1, wherein at the first preparing step, the silica glass tube to which chlorine is doped is prepared.

4. A method of manufacturing an optical fiber preform, the method comprising:
a first preparing step of preparing a silica glass tube;
a second preparing step of preparing a powder body containing an alkali metal component or an alkaline earth metal component, and silica powder;
a third preparing step of preparing a silica glass rod;
an inserting step of inserting the silica glass rod into the silica glass tube;
a filling step of filling a gap between the silica glass tube and the silica glass rod with the powder body;
a diffusing step of diffusing an alkali metal or an alkaline earth metal into the silica glass rod from the powder body through a heat treatment;
a removing step of removing the powder body that is not fixed to the silica glass rod, from the silica glass rod in which the alkali metal is diffused; and
a cladding portion forming step of forming a cladding portion so as to surround an outer periphery of the silica glass rod in which the alkali metal or the alkaline earth metal is diffused.

5. The method of manufacturing an optical fiber preform according to claim 4, wherein at the third preparing step, the silica glass rod to which chlorine is doped is prepared.

6. A method of manufacturing an optical fiber preform, the method comprising:
a first preparing step of preparing a silica glass tube;
a second preparing step of preparing a powder body containing an alkali metal component or an alkaline earth metal component, and silica powder;
a third preparing step of preparing a silica glass rod;
a filling step of filling the silica glass tube with the powder body;
a diffusing step of diffusing an alkali metal or an alkaline earth metal into the silica glass tube from the powder body through a heat treatment;
a removing step of removing the powder body that is not fixed to the silica glass tube, from the silica glass tube in which the alkali metal or the alkaline earth metal is diffused;
a jacketing step of jacketing the silica glass rod with the silica glass tube; and
a cladding portion forming step of forming a cladding portion so as to surround an outer periphery of the silica glass tube after the jacketing.

7. The method of manufacturing an optical fiber preform according to claim 6, wherein the silica glass tube to which chlorine is doped is prepared at the first preparing step and the silica glass rod to which chlorine is doped is prepared at the third preparing step.

8. The method of manufacturing an optical fiber preform according to claim 1, further comprising a second removing step of removing the powder body that is fixed to the silica glass tube or the silica glass rod after the removing step.

9. The method of manufacturing an optical fiber preform according to claim 1, wherein
the alkali metal component is contained as at least one kind of alkali metal compound among a silicate of the alkali metal, a carbonate of the alkali metal, a halide of the alkali metal, a nitrate of the alkali metal, a sulfate of the alkali metal, and a hydroxide of the alkali metal, and
the alkaline earth metal component is contained as at least one kind of alkaline earth metal compound among a silicate of the alkaline earth metal, a carbonate of the alkaline earth metal, a halide of the alkaline earth metal, a nitrate of the alkaline earth metal, a sulfate of the alkaline earth metal, and a hydroxide of the alkaline earth metal.

10. The method of manufacturing an optical fiber preform according to claim 1, wherein the heat treatment at the diffusing step is performed under a condition in which sintering of the silica powder does not progress significantly.

11. A method of manufacturing an optical fiber, comprising drawing an optical fiber preform manufactured by the method of manufacturing an optical fiber preform according to claim 1 to manufacture an optical fiber.

12. The method of manufacturing an optical fiber preform according to claim 4, further comprising a second removing step of removing the powder body that is fixed to the silica glass tube or the silica glass rod after the removing step.

13. The method of manufacturing an optical fiber preform according to claim 4, wherein
the alkali metal component is contained as at least one kind of alkali metal compound among a silicate of the alkali metal, a carbonate of the alkali metal, a halide of the alkali metal, a nitrate of the alkali metal, a sulfate of the alkali metal, and a hydroxide of the alkali metal, and
the alkaline earth metal component is contained as at least one kind of alkaline earth metal compound among a silicate of the alkaline earth metal, a carbonate of the alkaline earth metal, a halide of the alkaline earth metal, a nitrate of the alkaline earth metal, a sulfate of the alkaline earth metal, and a hydroxide of the alkaline earth metal.

14. The method of manufacturing an optical fiber preform according to claim 4, wherein the heat treatment at the diffusing step is performed under a condition in which sintering of the silica powder does not progress significantly.

15. A method of manufacturing an optical fiber, comprising drawing an optical fiber preform manufactured by the method of manufacturing an optical fiber preform according to claim 4 to manufacture an optical fiber.

16. The method of manufacturing an optical fiber preform according to claim 6, further comprising a second removing step of removing the powder body that is fixed to the silica glass tube or the silica glass rod after the removing step.

17. The method of manufacturing an optical fiber preform according to claim 6, wherein
the alkali metal component is contained as at least one kind of alkali metal compound among a silicate of the alkali metal, a carbonate of the alkali metal, a halide of the alkali metal, a nitrate of the alkali metal, a sulfate of the alkali metal, and a hydroxide of the alkali metal, and
the alkaline earth metal component is contained as at least one kind of alkaline earth metal compound among a silicate of the alkaline earth metal, a carbonate of the alkaline earth metal, a halide of the alkaline earth metal, a nitrate of the alkaline earth metal, a sulfate of the alkaline earth metal, and a hydroxide of the alkaline earth metal.

18. The method of manufacturing an optical fiber preform according to claim 6, wherein the heat treatment at the diffusing step is performed under a condition in which sintering of the silica powder does not progress significantly.

19. A method of manufacturing an optical fiber, comprising drawing an optical fiber preform manufactured by the method of manufacturing an optical fiber preform according to claim 6 to manufacture an optical fiber.
